(19) United States
(12) Patent Application Publication
(10) Pub. No.: US 2022/0111730 A1
(43) Pub. Date: Apr. 14, 2022

(54) VEHICULAR DISPLAY APPARATUS

(71) Applicant: SUBARU CORPORATION, Tokyo (JP)

(72) Inventor: Ryosuke KAKIMARU, Tokyo (JP)

(21) Appl. No.: 17/487,986

(22) Filed: Sep. 28, 2021

(30) Foreign Application Priority Data
Oct. 13, 2020 (JP) 2020-172345

(51) Int. Cl. B60K 35/00; G06F 3/02; G06F 3/0481; G06F 3/041; G06F 3/0484; G06F 3/0487

(52) U.S. Cl. CPC B60K 35/00; G06F 3/02; G06F 3/0481; G06F 3/041; B60K 2370/175; G06F 3/0487; B60K 2370/143; B60K 2370/152; B60K 2370/18; G06F 3/04842

(57) ABSTRACT

A vehicular display apparatus to be applied to a vehicle includes a display device and a generating unit. The display device is configured to display display screens in a switching manner. The display screens display status information of the vehicle in either of different combinations and layouts. The generating unit is configured to generate the display screens to be displayed in the switching manner on the display device. The generating unit is configured to generate the display screens to be displayed on the display device such that a status of either of a driving support function and an automated driving function of the vehicle is displayed on each of the display screens to be displayed in the switching manner on the display device.

### CROSS-REFERENCE TO RELATED APPLICATIONS

The present application claims priority from Japanese Patent Application No. 2020-172345 filed on Oct. 13, 2020, the entire contents of which are hereby incorporated by reference.

### BACKGROUND

The disclosure relates to vehicular display apparatuses.

Vehicles, such as automobiles, in the related art are provided with meter panels. Such a meter panel is provided in front of the driver driving the vehicle and is for displaying, for example, a speedometer and a warning lamp.

In recent years, such meter panels are becoming computerized, and small-size liquid crystal panels are embedded in the meter panels. For example, see Japanese Unexamined Patent Application Publication (JP-A) No. 2016-147657. Such a small-size liquid crystal panel may display, for example, the fuel level and route guidance.

With the display on the small-size liquid crystal panel provided in the meter panel, a vehicle occupant, such as the driver, can instantaneously check information displayed on the small-size liquid crystal panel without significantly changing the orientation of the vehicle occupant's head, similarly to a case where the vehicle occupant checks other information on the meter panel.

### SUMMARY

An aspect of the disclosure provides a vehicular display apparatus to be applied to a vehicle. The vehicular display apparatus includes a display device and a generating unit. The display device is configured to display display screens in a switching manner. The display screens display status information of the vehicle in either of different combinations and layouts. The generating unit is configured to generate the display screens to be displayed in the switching manner on the display device. The generating unit is configured to generate the display screens to be displayed on the display device such that a status of either of a driving support function and an automated driving function of the vehicle is displayed on each of the display screens to be displayed in the switching manner on the display device.

An aspect of the disclosure provides a vehicular display apparatus to be applied to a vehicle. The vehicular display apparatus includes a display device and circuitry. The display device is configured to display a display screens in a switching manner. The display screens display status information of a vehicle in either of different combinations and layouts. The circuitry is configured to generate the display screens to be displayed on the display device such that a status of either of a driving support function and an automated driving function of the vehicle is displayed on each of the display screens to be displayed in the switching manner on the display device.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to explain the principles of the disclosure.

FIG. 1 illustrates an automobile to which a display apparatus according to an embodiment of the disclosure is applied;

FIG. 2 illustrates an automotive control system that can serve as the display apparatus in the automobile in FIG. 1;

FIG. 3 illustrates a forward view from inside the automobile in FIG. 1;

FIG. 4A to FIG. 4C illustrate a plurality of display screens displayed on a meter display device in FIG. 2 and a method for switching display screens;

FIG. 5 is a flowchart of a display update control process performed on the meter display device by a cockpit control unit (CCU) in FIG. 2;

FIG. 6 is a flowchart of a display switching control process performed on the meter display device by the CCU in FIG. 2; and

FIG. 7A to FIG. 7D illustrate an example of the method for switching display screens on the meter display device in FIG. 2.

### DETAILED DESCRIPTION

JP-A No. 2018-106003 discloses a meter panel that is entirely constituted of a liquid crystal panel so as to serve as a meter display device.

In this case, in JP-A No. 2018-106003, it is conceivable that display elements to be displayed on the meter display device are switchable by a large degree, unlike a case where the display elements to be displayed on the meter display device are basically displayed at fixed positions. By utilizing the degree of freedom in the display of the meter display device, either of the combination and the layout of vehicle status information to be displayed is varied in a plurality of display screens, so that the vehicle occupant can be provided with a large amount of information that is difficult to provide in appropriate sizes and priority levels on a single display screen. The meter display device can switch display screens so as to provide information in a layout suitable for the vehicle occupant and to provide information at a priority level requested by the vehicle occupant.

However, if the combination of the vehicle status information to be displayed on the meter display device varies between the plurality of display screens, there is a possibility that the vehicle occupant traveling on the automobile may search for desired information to be checked on the meter display device. This may possibly make it difficult for the vehicle occupant to instantaneously check the desired information on the switched display screen, thus possibly having an adverse effect on the performance of the display apparatus used for checking while the vehicle, such as an automobile, is moving.

In particular, automobiles in recent years are being developed to have automotive driving support functions. It is desirable that the vehicle occupant appropriately check the operational status of such an automotive driving support function while the automobile is traveling.

Examples of information about the status of the automotive driving support function include information about the operational status of each function for the driving support mode and information about the recognition status according to the driving support function. The amount of information about the status of the automotive driving support function is significantly large, as compared with reading of either of the hand and the numerical value of a meter in the related art or checking of whether a warning lamp is lit. In order to display a large amount of information, a large display area is used.

It is desirable that the vehicle occupant can constantly and immediately check such a large amount of information even if the display on the meter display device is switched. The same applies to information about automated driving of the automobile.

If information about either of the driving support function and the automated driving function of the automobile is not displayed, the vehicle occupant is to switch display screens, search for information about either of the driving support function and the automated driving function on the switched display screen, and check the information.

For example, when the automobile switches from either of the driving support mode and the automated driving mode to the manual driving mode, it is demanded that the vehicle occupant immediately check the final mode of the automobile and perform a driving operation. However, with such display, time is consumed until the vehicle occupant actually starts performing the driving operation.

In a vehicular display apparatus that is to be checked in this manner while the vehicle is moving, it is desirable that the degree of freedom of displayable information be enhanced while an adverse effect on the checking of information by the vehicle occupant be reduced.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

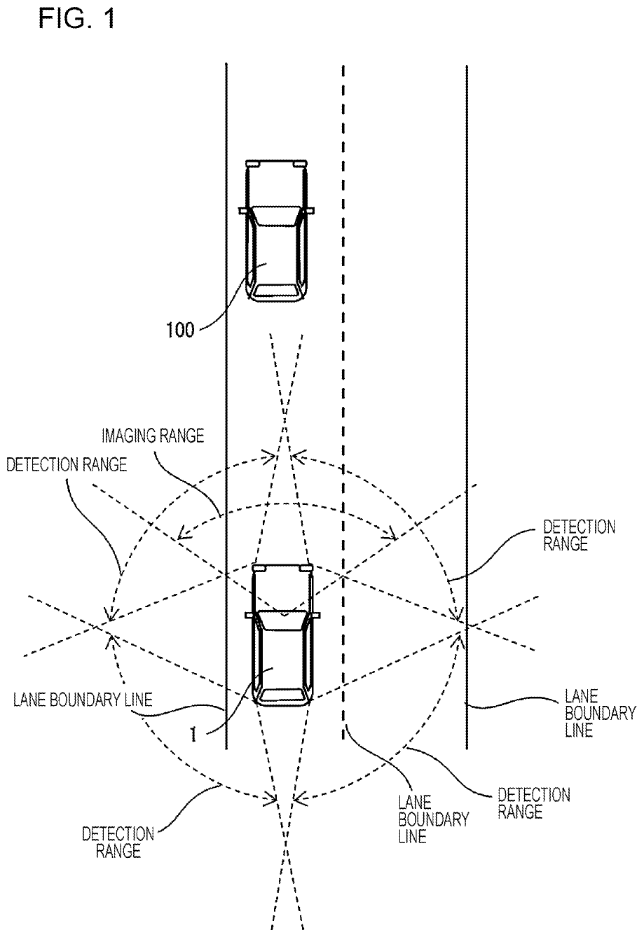

FIG. 1 illustrates an automobile 1 to which a display apparatus according to an embodiment of the disclosure is applied.

In addition to the automobile 1, FIG. 1 illustrates a two-lane road on which the automobile 1 is traveling, as well as a leading vehicle 100 running ahead of the automobile 1. A plurality of lanes provided on the road are each defined by lane boundary lines painted on the road surface along the left and right sides of the lane.

The automobile 1 is an example of a vehicle.

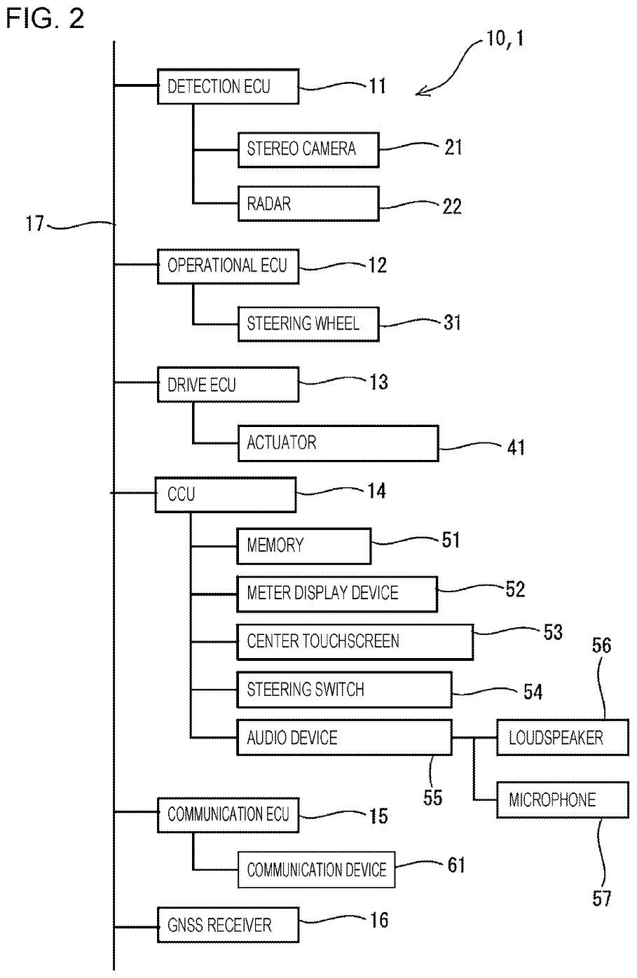

FIG. 2 illustrates a control system 10 of the automobile 1. The control system 10 can serve as the display apparatus in the automobile 1 in FIG. 1.

The control system 10 of the automobile 1 in FIG. 2 has a plurality of electronic control units (ECUs) for controlling the automobile 1. The plurality of control ECUs include, for example, a detection ECU 11, an operational ECU 12, a drive ECU 13, a cockpit control unit (CCU) 14 as a control ECU for controlling the display of a plurality of display devices, and a communication ECU 15. The control system 10 of the automobile 1 may include other control ECUs that are not illustrated. Furthermore, each control ECU may be coupled to, for example, a memory (not illustrated) that stores a program to be executed and data to be used by the control ECU. Each control ECU loads and executes the program stored in the memory to execute control.

The plurality of control ECUs are coupled to a vehicle network 17, such as any one of a controller area network (CAN), a local interconnect network (LIN), a local area network (LAN), FlexRay, and Clock Extension Peripheral Interface (CXPI), used in the automobile 1. The vehicle network 17 may be constituted of, for example, a plurality of bus cables coupled to the plurality of control ECUs and a central gateway (CGW) serving as a relay device to which the plurality of bus cables are coupled. The plurality of control ECUs can exchange messages with one another via the vehicle network 17. Accordingly, the plurality of control ECUs operate in cooperation with one another to control the automobile 1.

The vehicle network 17 in FIG. 2 is coupled to a global navigation satellite system (GNSS) receiver 16. The GNSS receiver 16 receives a radio wave from the GNSS, generates a message containing information, such as the current location of the automobile 1 and the current time point, and outputs the message to the vehicle network 17.

The detection ECU 11 is coupled to various detectors that detect the status of the automobile 1. In FIG. 2, a stereo camera 21 and a radar 22 are illustrated. The detection ECU 11 outputs, for example, detection values of the detectors and information based on the detection values to the vehicle network 17.

The stereo camera 21 has, for example, a plurality of cameras provided facing forward from the automobile 1. For example, the plurality of cameras may be disposed side-by-side in the vehicle width direction of the automobile 1. In this case, the plurality of cameras capture an image forward of the automobile 1. Such an image is indicated as an imaging range in FIG. 1. The detection ECU 11 may analyze the captured image and generate information about the traveling conditions of the automobile 1. For example, if the detection ECU 11 can analyze the captured image and extract a characteristic of the automobile 1, the detection ECU 11 may generate information about another automobile. For example, if the detection ECU 11 can analyze the captured image and extract a characteristic of lane boundary lines, the detection ECU 11 may generate information about the lane boundary lines. Based on a difference in imaging positions of subjects, such as another automobile, lane boundary lines, and so on, captured at different positions in the captured image of both cameras, the detection ECU 11 may calculate the relative direction and distance of the subjects from the automobile 1 trigonometrically based on the disposition of the plurality of cameras. Based on information about the imaging range of each subject in the captured image, the detection ECU 11 may estimate, for example, the type and the size of the subject. When the detection ECU 11 acquires, for example, the captured image including the lane boundary lines of the road on which the automobile 1 is traveling, the detection ECU 11 may estimate the shape and the width of the lane or road on which the automobile 1 is traveling based on the characteristic of the lane boundary lines.

The radar 22 has, for example, a plurality of ultrasonic sensors provided facing the surrounding area of the automobile 1 from the automobile 1. As illustrated in FIG. 1, the plurality of ultrasonic sensors may two-dimensionally or three-dimensionally detect four detection ranges, namely, a detection range centered on the rightward-forward direction from the automobile 1, a detection range centered on the leftward-forward direction from the automobile 1, a detection range centered on the rightward-rearward direction from the automobile 1, and a detection range centered on the leftward-rearward direction from the automobile 1. The four detection ranges in FIG. 1 cover 360° around the automobile 1. The detection ECU 11 may estimate an object existing around the automobile 1 from the detection patterns of the plurality of ultrasonic sensors serving as the radar 22. For example, a detection pattern that continues to exist in a fixed direction around the traveling automobile 1 may be estimated as a detection pattern of an object moving in the same direction as the automobile 1. The detection ECU 11 may calculate the distance to the object based on a period from transmission to reception of an ultrasonic wave when the detection pattern is detected.

Furthermore, the detection ECU 11 may integrate information obtained from these detectors to generate information about the traveling conditions of the automobile 1, such as information about an object serving as another automobile existing around the automobile 1, information about the lane boundary lines, information about the lane, and information about the road. The detection ECU 11 may generate, for example, the direction and the distance to a subject image-captured by the stereo camera 21 based on the detection information of the radar 22. The detection ECU 11 may further determine the traveling conditions of the automobile 1 based on the detection values of the detectors, such as whether the automobile 1 is traveling in the central area of the travel lane, whether the automobile 1 is traveling lopsidedly near the right edge of the travel lane, or whether the automobile 1 is traveling lopsidedly near the left edge of the travel lane, and may output information about the traveling conditions of the automobile 1 serving as the determination result to the vehicle network 17. In one embodiment, the detection ECU 11 may serve as an “acquiring unit” in the control system 10 of the automobile 1.

The operational ECU 12 is coupled to various operational devices to be operated by a vehicle occupant in the automobile 1. FIG. 2 illustrates a steering wheel 31. The vehicle occupant holds and operates the steering wheel 31 by using both hands, so as to maintain or change the traveling direction of the automobile 1. The automobile 1 basically changes the traveling direction based on a steering angle input as a result of the vehicle occupant operating the steering wheel 31. When the vehicle occupant operates an operational device, such as the steering wheel 31, the operational ECU 12 outputs, for example, an operational value of the operational device and information based on the operational value to the vehicle network 17. For example, when the steering wheel 31 is rotated rightward, the operational ECU 12 outputs information about the rightward operational direction and the operational amount of the steering wheel 31 to the vehicle network 17. Other examples of the operational devices include an accelerator pedal, a brake pedal, and a parking brake lever.

The drive ECU 13 serves as a controller that controls the traveling of the automobile 1. The drive ECU 13 is coupled to a plurality of actuators 41, including an actuator that controls the steering of the automobile 1, an actuator that controls the acceleration of the automobile 1, and an actuator that controls the braking of the automobile 1. The drive ECU 13 acquires information from another control ECU provided in the automobile 1 and causes the actuators 41 to operate, thereby controlling the traveling of the automobile 1.

In addition to controlling the movement of the automobile 1 based on, for example, information about a vehicle occupant's operation acquired from the operational ECU 12, the drive ECU 13 may execute driving support control by acquiring information obtained from the detection ECU 11 and related to the traveling condition on the lane on which the automobile 1 is traveling, and adjusting the information about the vehicle occupant's operation in accordance with the acquired information.

Together with information acquired by the communication ECU 15 and related to an automated driving path and a travelable range, the drive ECU 13 may acquire the information obtained from the detection ECU 11 and related to the traveling condition on the lane on which the automobile 1 is traveling, so as to execute automated driving control of the automobile 1.

The communication ECU 15 is coupled to a communication device 61. The communication device 61 establishes a communication path with, for example, a communication device of another automobile, a base station, and a portable terminal. By using the communication path established by the communication device 61, the communication ECU 15 communicates and exchanges information with, for example, a server that assists in the traveling and the automated driving of the automobile 1. The communication ECU 15 acquires, from another control ECU via the vehicle network 17, information to be transmitted, and transmits the information to the server. The communication ECU 15 outputs information received from the server to another control ECU via the vehicle network 17. Information to be received by the communication ECU 15 includes, for example, information about an automated driving path and a travelable range of the automobile 1.

The CCU 14 controls, for example, the display of the plurality of display devices provided in the automobile 1 so as to cause the plurality of display devices to display information about various kinds of statuses in the automobile 1. FIG. 2 illustrates a meter display device 52 and a center touchscreen 53 as the display devices.

The meter display device 52 may be a display panel, such as a liquid crystal panel.

The center touchscreen 53 may be formed by laminating a transparent touch-sensitive panel over a display panel, such as a liquid crystal panel, so long as the center touchscreen 53 can detect an operation performed on the display by the vehicle occupant.

Examples of status information of the automobile 1 include information about the traveling conditions of the automobile 1, information about the operational status of each device of the automobile 1, information about the operational status of an air conditioner used in the automobile 1, information about the operational status of an audio visual device, such as an audio device 55, information about the operational statuses of other equipment, information about the settings of these devices and equipment, and information related to communication. If the automobile 1 is capable of traveling in either one of a driving support mode and an automated driving mode, information about the operational status of either of the driving support function and the automated driving function and information about the recognition status by either of the driving support function and the automated driving function may be included. Examples of the driving support function and the automated driving function include a lane keep function, a tracking function for following the leading vehicle 100, and a maximum-speed control function.

The CCU 14 may acquire information from each unit of the automobile 1, generate a display element according to the acquired information, generate a display screen in which a plurality of display elements are laid out, and cause each display device to display the display screen.

For example, the CCU 14 may cause the center touchscreen 53 to display information about map data and generate a route to a destination based on an operation performed on the center touchscreen 53 by the vehicle occupant.

Furthermore, while the automobile 1 is traveling, the CCU 14 may cause either one of the meter display device 52 and the center touchscreen 53 to display information about route guidance to the destination and information about the road conditions ahead from the current location acquired by the GNSS receiver 16.

Moreover, while the automobile 1 is traveling, the CCU 14 may output a path based on the generated route to the drive ECU 13 as information about a path to be used for automated driving.

In addition to the plurality of display devices, the CCU 14 in FIG. 2 is coupled to a memory 51, a steering switch 54, and the audio device 55.

The memory 51 stores a program to be executed and data to be used by the CCU 14. The CCU 14 loads and executes the program stored in the memory 51 to serve as, for example, a display controller.

The steering switch 54 is a physical switch that is provided in the steering wheel 31 and that detects an operation performed by the vehicle occupant. In one embodiment, the steering switch 54 may serve as a “second operational member”. The steering switch 54 may be provided in the steering wheel 31 such that, for example, the vehicle occupant holding the steering wheel 31 can reach the steering switch 54 with a finger while holding the steering wheel 31. Accordingly, the driver can operate the steering switch 54 by simply stretching a finger of the hand holding the steering wheel 31 without visually checking the location of the steering switch 54.

The audio device 55 reproduces, for example, various kinds of audio data and outputs the audio data from a loudspeaker 56. The audio data may contain, for example, the status of either of the driving support function and the automated driving function, and guidance for changing or terminating driving control. The audio device 55 may output, to the CCU 14, displayable information about the audio data to be reproduced. Moreover, the audio device 55 acquires a sound, such as the vehicle-occupant's voice, collected from a microphone 57, and outputs the sound to the CCU 14. The audio device 55 may analyze the collected sound and output a command corresponding to the analyzed sound to the CCU 14.

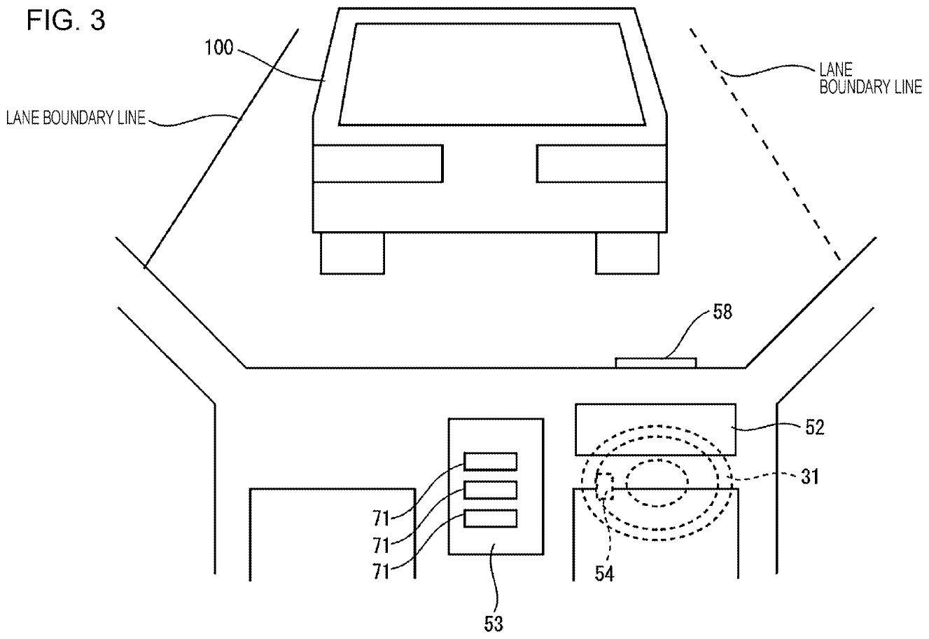

FIG. 3 illustrates a forward view from inside the automobile 1 in FIG. 1.

As illustrated in FIG. 3, the meter display device 52 is disposed in front of the driver and at the right side of a dashboard of the automobile 1. The steering wheel 31 to be operated by the driver is disposed such as to be located between the meter display device 52 and the driver. The steering wheel 31 is provided with the steering switch 54.

A monitor lamp 58 that displays the status of either of the driving support function and the automated driving function in a simplified manner is disposed in an upper area of the dashboard above the meter display device 52.

The center touchscreen 53 is disposed in a central area of the dashboard of the automobile 1. The center touchscreen 53 in FIG. 3 displays a plurality of selection buttons 71 respectively corresponding to a plurality of display screens of the meter display device 52, to be described later.

The center touchscreen 53 displays the plurality of selection buttons 71 respectively corresponding to the plurality of display screens and detects that any one of the displayed buttons is selected by the vehicle occupant. In one embodiment, the center touchscreen 53 serves as a “first operational member”.

As an alternative to FIG. 3, the center touchscreen 53 may display a next button and a back button to be used for switching between the plurality of display screens in a predetermined sequence and detect that any one of the displayed buttons is selected by the vehicle occupant.

The driver checks the displayed information as well as the conditions of the road and the leading vehicle 100 visually recognizable through the windshield, and maneuvers the automobile 1. In the visual field through the windscreen in FIG. 3, the left and right lane boundary lines and the leading vehicle 100 are illustrated in correspondence to FIG. 1.

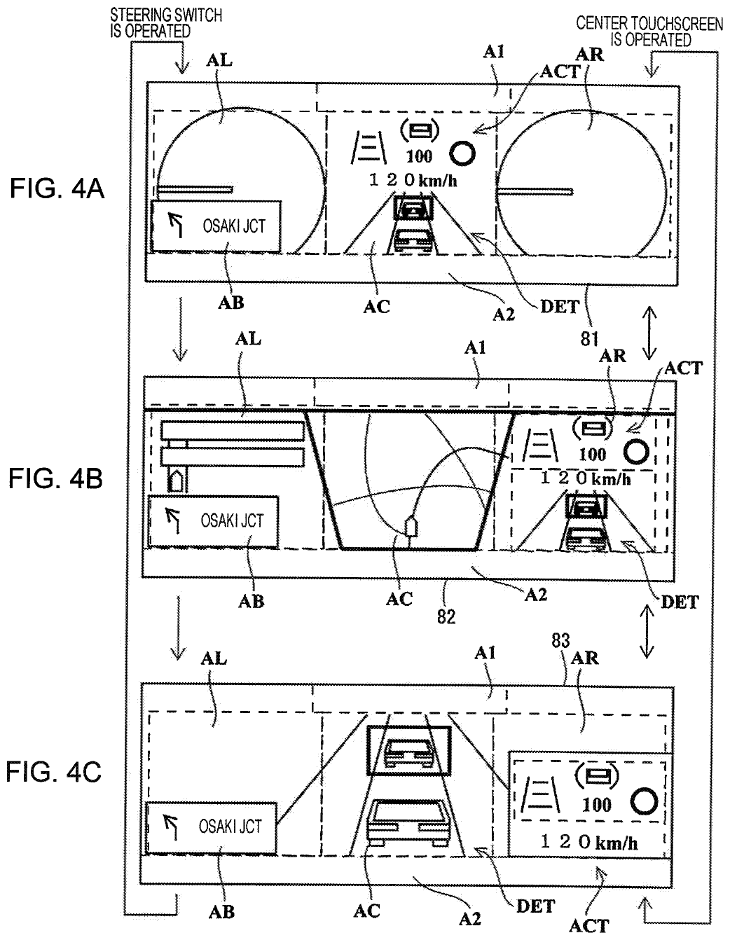

FIG. 4A to FIG. 4C illustrate the plurality of display screens displayed on the meter display device 52 in FIG. 2 and a method for switching display screens.

FIG. 4A illustrates a normal display screen 81.

FIG. 4B illustrates a map-prioritized display screen 82.

FIG. 4C illustrates a driving-support-prioritized display screen 83.

Each of the display screens 81 to 83 has an upper telltale region A1 extending in the left-right direction along the upper edge, a lower telltale region A2 extending in the left-right direction along the lower edge, a central region AC between the upper telltale region A1 and the lower telltale region A2, and a left region AL and a right region AR at the left and right sides of the central region AC.

The upper telltale region A1 and the lower telltale region A2 each display a plurality of pieces of basic information of the automobile 1 that are common among all the display screens. The basic information may be displayed using a display element whose color changes correspondingly to the content of the information. The basic information may contain information displayed using various warning lamps in the automobile 1 in the related art. The pieces of information are allocated to fixed display positions that are common among all the display screens.

The central region AC, the right region AR, and the left region AL are capable of displaying information to be displayed in a switching manner.

In the normal display screen 81 in FIG. 4A, information about the status of the driving support function is allocated to and displayed in the central region AC, an image of a speedometer indicating the latest speed is allocated to and displayed in the right region AR, and an image of a tachometer indicating the latest engine rotation speed is allocated to and displayed in the left region AL. A lower area of the left region AL displays a window region AB that displays other information. The window region AB displays, for example, information about the traveling direction at the next turning point and information about a music track being played.

An upper area of the central region AC displays a plurality of display elements corresponding to a plurality of functions for the driving support mode. Examples of the display elements include a circle mark indicating the operational status of the driving support function, a lane mark indicating the operational status of the lane keep function, a vehicle mark indicating the operational status of the tracking function for following the leading vehicle 100, and an upper-limit speed value indicating the maximum speed in the driving support mode. The presence and absence of each display element and the color thereof may be changed in accordance with the latest operational status of the corresponding function. For example, a display element for a non-operating function may be canceled by changing the color thereof to the same dark color as the background color, so that a display element for an operating function alone is displayed in a distinguishable manner. In accordance with the accuracy or inaccuracy of detection or control with respect to each function, a chromatic color given to the corresponding display element may be changed. The plurality of display elements entirely serve as first display ACT indicating the overall operational status of either of the driving support function and the automated driving function. Because the relative display positions are fixed among the plurality of display elements, the vehicle occupant can easily ascertain, for example, the operational statuses of the functions based on the layout of the plurality of display elements even when the display positions are entirely shifted.

A lower area of the central region AC displays, as a display element, a schematized image depicting the recognition status of the lane boundary lines on the road and the leading vehicle 100 according to the driving support function. If the lane boundary lines are not recognized, the display of the lane boundary lines may be removed from the image. If the leading vehicle 100 is not recognized, the display of the leading vehicle 100 and the display of a recognition frame may be removed from the image. The schematized image depicting the recognition status serves as second display DET indicating the recognition status according to either of the driving support function and the automated driving function.

Accordingly, the information about either of the driving support function and the automated driving function contains a large amount of information about the display elements.

In the map-prioritized display screen 82 in FIG. 4B, route-guidance map information is allocated to and displayed in the central region AC, the first display ACT and the second display DET constituting the information about the status of the driving support function are allocated to and displayed in the right region AR, and information about a transit point, such as a turning point, in the route guidance is allocated to and displayed in the left region AL. A lower area of the left region AL displays the window region AB displaying other information.

An upper area of the right region AR displays a plurality of display elements corresponding to a plurality of functions for the driving support mode. A lower area of the right region AR displays a schematized image depicting the recognition status of the lane boundary lines on the road and the leading vehicle 100 according to the driving support function.

In the driving-support-prioritized display screen 83 in FIG. 4C, the schematized image depicting the recognition status of the lane boundary lines on the road and the leading vehicle 100 according to the driving support function in the information about the status of the driving support function is allocated to the central region AC and displayed as the second display DET, and the plurality of display elements corresponding to the plurality of functions for the driving support mode are allocated to the right region AR and displayed as the first display ACT. A dedicated display element is not allocated to the left region AL. The lower area of the left region AL displays the window region AB displaying other information.

Accordingly, the combination of the status information of the automobile 1 to be displayed in the central region AC, the right region AR, and the left region AL varies among the plurality of display screens 81 to 83 in FIG. 4A to FIG. 4C. In particular, in the driving-support-prioritized display screen 83 in FIG. 4C, the schematized image depicting the recognition status of the lane boundary lines on the road and the leading vehicle 100 according to the driving support function in the information about the status of the driving support function and the plurality of display elements corresponding to the plurality of functions for the driving support mode are displayed separately in the central region AC and the right region AR in a layout different from that of other displayed images.

The CCU 14 selects one of the plurality of display screens 81 to 83 in FIG. 4A to FIG. 4C, generates the selected display screen based on latest information, and displays the generated display screen on the meter display device 52. In one embodiment, the CCU 14 serves as a “generating unit”.

The CCU 14 displays the status of either of the driving support function and the automated driving function of the automobile 1 commonly on all the display screens 81 to 83 to be displayed in a switching manner on the meter display device 52.

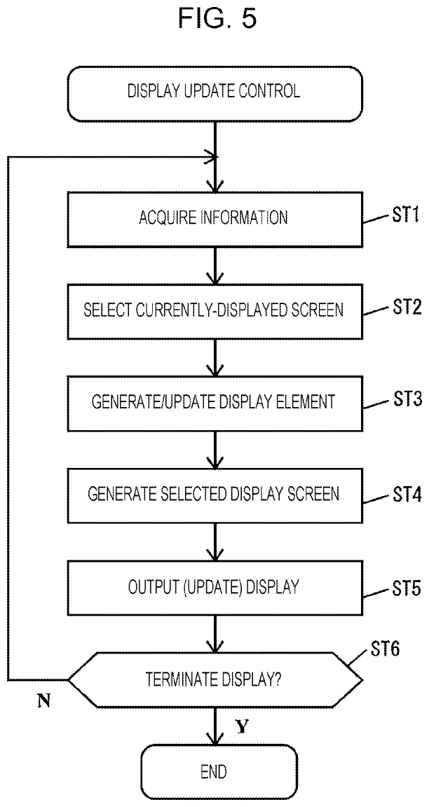

FIG. 5 is a flowchart of a display update control process performed on the meter display device 52 by the CCU 14 in FIG. 2.

The CCU 14 starts the control process in FIG. 5 based on, for example, an operation performed on an ignition switch (not illustrated) of the automobile 1.

In the control process in FIG. 5, the CCU 14 repeatedly generates a display screen to be displayed on the meter display device 52 updates the display of the meter display device 52.

In step ST1, the CCU 14 acquires various kinds of information to be used for generating the display screen from various units of the automobile 1. The CCU 14 may basically acquire information to be used for generating the plurality of display screens in FIG. 4A to FIG. 4C. The CCU 14 acquires information about the status of the driving support function as minimal information.

In step ST2, the CCU 14 selects a currently-displayed screen. The CCU 14 may select one display screen from the plurality of display screens in FIG. 4A to FIG. 4C, and set the selected display screen as the currently-displayed screen.

In step ST3, the CCU 14 generates each display element to be displayed on the display screen. If there is a change in information of the automobile 1 corresponding to the display element, the display element is updated to a new one.

For example, if there is a change in the temperature of the engine from a state lower than a previous threshold value to a state higher than the threshold value, the CCU 14 changes the color of the display element corresponding to the engine temperature from blue to orange.

In addition, for example, if an operation for starting either of the driving support function and the automated driving function is performed, the CCU 14 updates a circle mark indicating that the driving support function is in operation from an unlit mode to a lit mode. If the lane keep function is in operation, the CCU 14 updates a lane mark indicating that the lane keep function can be started from an unlit mode to a lit mode. When the lane boundary lines can be recognized in accordance with the lane keep function, the CCU 14 updates the recognized lane boundary lines from an unlit mode to a lit mode in a schematized image depicting the recognition status according to the driving support function. When the lane boundary lines are no longer recognizable in accordance with the lane keep function, the CCU 14 updates the recognized lane boundary lines from the lit mode to the unlit mode in the schematized image depicting the recognition status according to the driving support function.

In step ST4, the CCU 14 generates the display screen selected in step ST2. The CCU 14 generates the display screen by allocating the plurality of display elements generated in step ST3 in accordance with the disposition and the size of the selected display screen.

In step ST5, the CCU 14 outputs the display screen generated in step ST4 to the meter display device 52. Accordingly, the meter display device 52 updates the display screen selected as the currently-displayed screen to a new display screen.

In step ST6, the CCU 14 determines whether to terminate the display of the display screen. For example, the CCU 14 may determine whether to terminate the display of the display screen based on an operation performed on the ignition switch (not illustrated) of the automobile 1. If the display of the display screen is not to be terminated, the CCU 14 returns to step ST1. In this case, the CCU 14 repeats the update of the display of the meter display device 52 in accordance with the display screen selected as the currently-displayed screen. If the display of the display screen is to be terminated, the CCU 14 ends the control process.

Then, when the steering switch 54 is operated once or when any one of the selection buttons 71 on the center touchscreen 53 is operated, the CCU 14 selects another display screen from the plurality of display screens 81 to 83, generates the newly-selected display screen, and displays the generated display screen on the meter display device 52.

Accordingly, the meter display device 52 can display the plurality of display screens 81 to 83 displaying different information and having different layouts in a switching manner.

Furthermore, the CCU 14 can generate the plurality of display screens 81 to 83 to be displayed in a switching manner on the meter display device 52.

In one embodiment, the center touchscreen 53 and the steering switch 54 may respectively serve as a “first operational member” and a “second operational member”. The center touchscreen 53 and the steering switch 54 are operable by the vehicle occupant of the automobile 1 for switching display screens to be displayed on the meter display device 52.

For example, as illustrated in FIG. 4A to 4C, every time the steering switch 54 is operated, the CCU 14 switches display screens to be displayed on the meter display device 52 by selecting the normal display screen 81, the map-prioritized display screen 82, and the driving-support-prioritized display screen 83 in that order. After the driving-support-prioritized display screen 83, the CCU 14 selects the normal display screen 81.

When the selection button 71 corresponding to the normal display screen 81 is operated on the center touchscreen 53, if the CCU 14 has previously selected either one of the map-prioritized display screen 82 and the driving-support-prioritized display screen 83, the CCU 14 selects the normal display screen 81 and switches the display screen to be generated and displayed on the meter display device 52 to the normal display screen 81.

When the selection button 71 corresponding to the map-prioritized display screen 82 is operated on the center touchscreen 53, if the CCU 14 has previously selected either one of the normal display screen 81 and the driving-support-prioritized display screen 83, the CCU 14 selects the map-prioritized display screen 82 and switches the display screen to be generated and displayed on the meter display device 52 to the map-prioritized display screen 82.

When the selection button 71 corresponding to the driving-support-prioritized display screen 83 is operated on the center touchscreen 53, if the CCU 14 has previously selected either one of the normal display screen 81 and the map-prioritized display screen 82, the CCU 14 selects the driving-support-prioritized display screen 83 and switches the display screen to be generated and displayed on the meter display device 52 to the driving-support-prioritized display screen 83.

By constituting the meter display device 52 entirely of a liquid crystal panel in this manner so that the meter display device 52 is capable of displaying a plurality of display screens in a switching manner, the amount of information displayable on the meter display device 52 can be significantly increased without largely impairing the visibility of the information. By utilizing the degree of freedom in the display of the meter display device 52, either of the combination and the layout of status information of the automobile 1 to be displayed is varied in the plurality of display screens 81 to 83, so that the vehicle occupant can be provided with a large amount of information that is difficult to provide in appropriate sizes and priority levels on a single display screen. The meter display device 52 can switch display screens so as to provide information in a layout suitable for the vehicle occupant and to provide information at a priority level requested by the vehicle occupant.

However, if the combination of the status information of the automobile 1 to be displayed on the meter display device 52 varies between the plurality of display screens 81 to 83, there is a possibility that the vehicle occupant may search for desired information to be checked on the screen displayed on the meter display device 52 of the traveling automobile 1. This may possibly make it difficult for the vehicle occupant to instantaneously check the desired information on the switched display screen, thus possibly having an adverse effect on the performance of the display apparatus in the automobile 1.

In particular, automobiles 1 in recent years are equipped with a driving support function, as in the automobile 1 according to this embodiment. It is desirable that the vehicle occupant appropriately check the operational status of such a driving support function of the automobile 1 while the automobile 1 is traveling.

Information about the status of the driving support function of the automobile 1 include a large amount of information, such as information about the operational status of each function for the driving support mode on the first display ACT and information about the recognition status according to the driving support function on the second display DET. The amount of information for displaying the status of the driving support function of the automobile 1 is significantly large, as compared with reading of either of the hand and the numerical value of a meter in the related art or checking of whether a warning lamp is lit. In order to display a large amount of information, a large display area is used. Therefore, in this embodiment, the entire central region AC of the meter display device 52 is used, as mentioned above, and the entire right region AR is used. The status of either of the driving support function and the automated driving function of the automobile 1 is displayed on one or more of the display screens in a region located at a position different from and with a size different from the remaining one or more of the display screens. At least one of the first display ACT displaying the status of either of the driving support function and the automated driving function of the automobile 1 and indicating the operational status of each function for either of the driving support mode and the automated driving mode or the second display DET indicating the recognition status according to either of the driving support function and the automated driving function is displayed on one or more of the plurality of display screens 81 to 83 in a region located at a position different from and with a size different from the remaining one or more of the display screens.

While such display is implemented on the meter display device 52, it is desired that the vehicle occupant constantly and quickly check the information even if the display on the meter display device 52 is switched. In particular, it is desirable that the information about either of the driving support function and the automated driving function of the automobile 1 be checked immediately depending on the circumstances. Therefore, in this embodiment, as illustrated in FIG. 4A to 4C, the information about the status of the driving support function of the automobile 1 is displayed on all the display screens 81 to 83. Accordingly, there is no display screen not displaying the information about the status of the driving support function of the automobile 1, so that the vehicle occupant can immediately check the information about the status of the driving support function displayed on the already-displayed screen without performing a display-screen switching operation. For example, when the automobile 1 switches from either of the driving support mode and the automated driving mode to the manual driving mode regardless of the intention of the vehicle occupant, the vehicle occupant can immediately check the final status of the automobile 1 and perform a driving operation. The vehicle occupant can check the displayed information about either of the driving support function and the automated driving function within a short period of time, and can start performing an operation accordingly.

Furthermore, in this embodiment, the vehicle occupant can immediately check the information about the status of either of the driving support function and the automated driving function of the automobile 1 when the screen displayed on the meter display device 52 is being switched to another one and also immediately after the screen is switched to another one. The vehicle occupant can check the information about the status of either of the driving support function and the automated driving function of the automobile 1 on the switched display screen newly displayed on the meter display device 52 without searching for the display position of the information. This will be described in detail below.

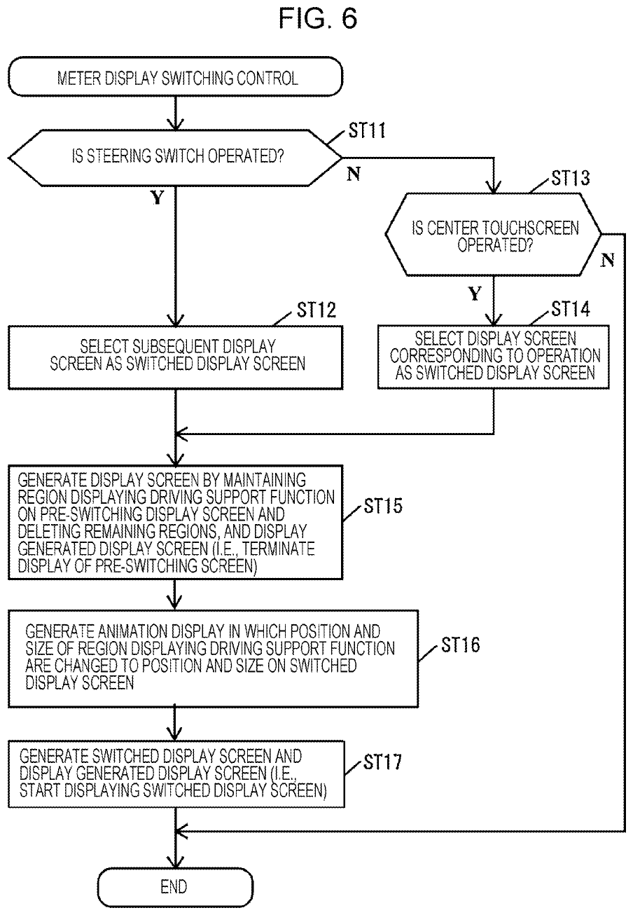

FIG. 6 is a flowchart of a display switching control process performed on the meter display device 52 by the CCU 14 in FIG. 2.

The CCU 14 repeatedly performs the control in FIG. 5 and the control in FIG. 6. For example, when the steering switch 54 is operated or when any one of the selection buttons 71 on the center touchscreen 53 is operated, the CCU 14 may execute the process in FIG. 6. In one embodiment, the CCU 14 may serve as a “generating unit”.

By performing the control in FIG. 6, the CCU 14 switches the display screen to be displayed on the center touchscreen 53 from a pre-switching display screen selected and displayed before the switching process to a newly-selected display screen. The CCU 14 newly selects a single display screen from the plurality of display screens illustrated in FIG. 4A to FIG. 4C, generates the newly-selected display screen, and displays the generated display screen on the meter display device 52.

In step ST11, the CCU 14 determines whether the steering switch 54 is operated for switching the display of the meter display device 52. If the steering switch 54 is operated, the CCU 14 proceeds to step ST12. If the steering switch 54 is not operated, the CCU 14 proceeds to step ST13.

In step ST12, the CCU 14 selects a display screen subsequent to the currently-selected-and-displayed pre-switching display screen as a switched display screen. With regard to the plurality of display screens to be displayed in a switching manner on the meter display device 52, a predetermined switching sequence is preliminarily set in accordance with the specifications or by the user. Switching-sequence setting data may be stored in the memory 51. The CCU 14 loads the switching-sequence setting data from the memory 51 and identifies a display screen to be displayed subsequently to the currently-selected pre-switching display screen. Subsequently, the CCU 14 proceeds to step ST15.

In step ST13, the CCU 14 determines whether any one of the selection buttons 71 on the center touchscreen 53 is operated for switching the display of the meter display device 52. The center touchscreen 53 can display the plurality of selection buttons 71 to be used for switching the display of the meter display device 52. When one of the selection buttons 71 on the center touchscreen 53 is operated for switching the display of the meter display device 52, the CCU 14 proceeds to step ST14. If none of the selection buttons 71 is operated, the CCU 14 ends the control process.

In step ST14, the CCU 14 selects the display screen corresponding to the operated selection button 71 as a switched display screen. Then, the CCU 14 proceeds to step ST15.

In step ST15, the CCU 14 ends the display of the currently-selected pre-switching display screen and starts performing a process for displaying that the display screen is to be switched to another one. The CCU 14 first generates a display screen by maintaining the display of the region displaying the status of either of the driving support function and the automated driving function of the automobile 1 among the central region AC, the right region AR, and the left region AL on the pre-switching display screen, and deleting the remaining regions. On this display screen, the upper telltale region A1, the lower telltale region A2, and the window region AB on the pre-switching display screen may also be maintained. The meter display device 52 basically displays a screen that displays the status of either of the driving support function and the automated driving function of the automobile 1.

In step ST16, the CCU 14 generates animation display in which the maintained region displaying the status of either of the driving support function and the automated driving function of the automobile 1 is changed from the display position and the display size on the pre-switching display screen to the display position and the display size on the switched display screen. From the meter display device 52, the display of the regions other than the region displaying the status of either of the driving support function and the automated driving function of the automobile 1 among the central region AC, the right region AR, and the left region AL on the pre-switching display screen has already been deleted. The region displaying the status of either of the driving support function and the automated driving function of the automobile 1 is displayed on the meter display device 52 such as to shift in front of the background darkened due to the deletion from the pre-switching display position to the switched display position. Because the background is darkened to have black color, the driver can clearly recognize that the region displaying the status of either of the driving support function and the automated driving function of the automobile 1 has been shifted, and can also clearly recognize the location of a region that is to serve as a shifting destination.

In step ST17, the CCU 14 generates a newly-selected switched display screen. The meter display device 52 starts to display the switched display screen. The meter display device 52 displays the entire switched display screen after the region displaying the status of either of the driving support function and the automated driving function of the automobile 1 reaches the position and the size on the switched display screen.

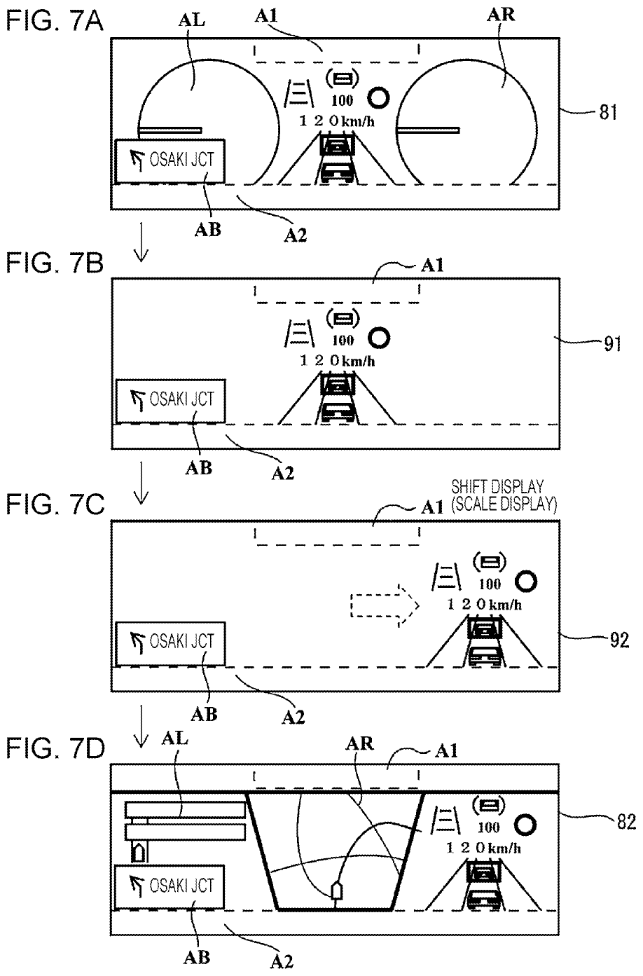

FIG. 7A to FIG. 7D illustrate an example of the method for switching display screens on the meter display device 52 in FIG. 2.

When the CCU 14 in FIG. 2 switches the normal display screen 81 in FIG. 4A to the map-prioritized display screen 82 in FIG. 4B in the display switching control process performed on the meter display device 52 in FIG. 6, the CCU 14 sequentially displays screens in FIG. 7A to FIG. 7D on the meter display device 52.

FIG. 7A illustrates a display screen displayed on the meter display device 52 before the switching process. The display screen in FIG. 7A is the normal display screen 81 in FIG. 4A.

FIG. 7B illustrates a display screen 91 displayed first on the meter display device 52 during the switching process. The display screen 91 in FIG. 7B is to be generated in step ST15 and is obtained by deleting the right region AR and the left region AL from the normal display screen 81 in FIG. 4A. The display of the status of either of the driving support function and the automated driving function of the automobile 1 in the central region AC of the normal display screen 81 is maintained on the display screen 91.

FIG. 7C illustrates a display screen 92 displayed on the meter display device 52 subsequently to FIG. 7B during the switching process. The display screen 92 in FIG. 7C is generated in step ST16 and is an animation display screen in which the maintained display of the status of either of the driving support function and the automated driving function of the automobile 1 has been shifted from the central region AC on the normal display screen 81 in FIG. 4A toward the right region AR on the map-prioritized display screen 82 in FIG. 4B, as indicated with a dashed arrow in FIG. 7C.

FIG. 7D illustrates a display screen displayed on the meter display device 52 after the switching process. The display screen in FIG. 7D is the map-prioritized display screen 82 in FIG. 4B.

Accordingly, the meter display device 52 is capable of displaying the plurality of display screens 81 to 83, displaying the status information of the automobile 1 in different combinations or layouts, in a switching manner. By switching display screens to be displayed on the meter display device 52, the vehicle occupant can be provided with a large amount of information that is difficult to provide in appropriate sizes and priority levels on a single display screen.

In addition, in this embodiment, the status of either of the driving support function and the automated driving function of the automobile 1 is displayed commonly on all the display screens 81 to 83 to be displayed in a switching manner on the meter display device 52. Accordingly, without performing an operation for switching display screens to be displayed on the meter display device 52, the vehicle occupant can check the status of either of the driving support function and the automated driving function of the automobile 1. For example, when the automobile 1 switches from either of the driving support mode and the automated driving mode to the manual driving mode, the vehicle occupant can check the status of either of the driving support function and the automated driving function on the already-displayed screen without performing a display-screen switching operation, and can immediately start performing a driving operation.

Accordingly, in this embodiment, the degree of freedom in the display of the meter display device 52 of the automobile 1 can be enhanced, while an adverse effect on the vehicle occupant's process for checking the status of either of the driving support function and the automated driving function of the automobile 1 is less likely to occur.

In this embodiment, at least one of the display screens 81 to 83 to be displayed in a switching manner on the meter display device 52 displays the status of either of the driving support function and the automated driving function of the automobile 1 in a region located at a position different from and with a size different from the remaining display screens. Accordingly, the degree of freedom in the display layout of the meter display device 52 is enhanced, while a state where the status of either of the driving support function and the automated driving function of the automobile 1 is constantly displayed is ensured. In particular, in this embodiment, the display of the status of either of the driving support function and the automated driving function of the automobile 1 involves a large amount of information and is separated into the first display ACT indicating the operational status of either of the driving support function and the automated driving function and the second display DET indicating the recognition status according to either of the driving support function and the automated driving function. Because the first display ACT and the second display DET can be individually laid out on the display screen, the degree of freedom in the display layout of the meter display device 52 can be further enhanced.

In addition, in this embodiment, when the display screen to be displayed on the meter display device 52 is to be switched, the display screen 91 is generated by maintaining the display of the region displaying the status of either of the driving support function and the automated driving function of the automobile 1 and at least partially deleting the remaining regions from the pre-switching display screen. Then, the animation-based display screen 92 in which the maintained region displaying the status of either of the driving support function and the automated driving function of the automobile 1 is changed to the display position and the display size on the switched display screen is generated. After the region displaying the status of either of the driving support function and the automated driving function of the automobile 1 reaches the position and the size on the switched display screen, a process for generating the switched display screen is started. With the animation display, the display shifts during the screen switching process, so that the vehicle occupant can easily and preliminarily ascertain the position of the region displaying either of the driving support function and the automated driving function on the switched display screen. Subsequently, even if the automobile 1 immediately switches from, for example, either of the driving support mode and the automated driving mode to the manual driving mode, the vehicle occupant can check the status of either of the driving support function and the automated driving function by simply viewing the already-recognized display position, so that the vehicle occupant can immediately start performing a driving operation immediately after the driving mode is switched. In this embodiment, regardless of the fact that the plurality of display screens 81 to 83 with an enhanced degree of freedom in information on the meter display device 52 are displayed in a switching manner, the vehicle occupant can quickly check the status of either of the driving support function and the automated driving function at the same speed as a case where the contents on the screen are fixedly displayed, and can also quickly start performing an operation for coping with a situation that has occurred.

In this embodiment, when the center touchscreen 53 is operated, the display screen selected as a result of the vehicle occupant's operation is selected as a display screen to be displayed on the meter display device 52. In contrast, in a case where the steering switch 54 is operated, a selection screen subsequent to the currently-displayed selection screen is selected as a display screen to be displayed on the meter display device 52 in a predetermined sequence preliminarily set for the plurality of display screens 81 to 83. For example, while monitoring ahead, the driver can switch the display screen displayed on the meter display device 52 to a desired display screen by simply operating the steering switch 54 in front of the driver or in accordance with the number of times the steering switch 54 is operated. Furthermore, the center touchscreen 53 displays the plurality of selection buttons 71 that correspond to the plurality of display screens 81 to 83 in a one-to-one fashion, so that the display screen to be displayed on the meter display device 52 can be switched directly with a small number of operations. Even if the number of display screens to be displayed on the meter display device 52 is three or more, the vehicle occupant including the driver can switch the display screen to be displayed on the meter display device 52 to a desired display screen by performing a simple operation for a small number of times.

Although the above embodiment is an example of a preferred embodiment of the disclosure, the embodiment of the disclosure is not to be limited to the above embodiment, and various modifications or alterations are possible so long as they do not depart from the gist of the disclosure.

The control system 10 illustrated in FIG. 2 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control system 10 including the detection ECU 11, the operational ECU 12, the drive ECU 13, the CCU 14, and the communication ECU 15. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 2.

1. A vehicular display apparatus to be applied to a vehicle, the vehicular display apparatus comprising:
a display device configured to display display screens in a switching manner, the display screens displaying status information of the vehicle in either of different combinations and layouts; and
a generating unit configured to generate the display screens to be displayed in the switching manner on the display device,
wherein the generating unit is configured to
generate the display screens to be displayed on the display device such that a status of either of a driving support function and an automated driving function of the vehicle is displayed on each of the display screens to be displayed in the switching manner on the display device.

2. The vehicular display apparatus according to claim 1,
wherein the generating unit is configured to
generate the display screens such that at least one of the display screens to be displayed in the switching manner on the display device displays the status of either of the driving support function and the automated driving function of the vehicle in a region different from a remaining one or more of the display screens.

3. The vehicular display apparatus according to claim 1,
wherein the display of the status of either of the driving support function and the automated driving function of the vehicle comprises first display indicating an operational status of either of the driving support function and the automated driving function and second display indicating a recognition status according to either of the driving support function and the automated driving function, and
wherein the generating unit is configured to
generate the display screens such that a region for at least one of the first display or the second display in at least one of the display screens to be displayed in the switching manner on the display device is different from a remaining one or more of the display screens.

4. The vehicular display apparatus according to claim 2,
wherein the display of the status of either of the driving support function and the automated driving function of the vehicle comprises first display indicating an operational status of either of the driving support function and the automated driving function and second display indicating a recognition status according to either of the driving support function and the automated driving function, and
wherein the generating unit is configured to
generate the display screens such that a region for at least one of the first display or the second display in at least one of the display screens to be displayed in the switching manner on the display device is different from a remaining one or more of the display screens.

5. The vehicular display apparatus according to claim 1,
wherein, when the display screens to be displayed on the display device are to be switched, the generating unit is configured to
generate a display screen by maintaining the display of a region displaying the status of either of the driving support function and the automated driving function of the vehicle in a pre-switching display screen and at least partially deleting a remaining region from the pre-switching display screen,
generate a display screen by changing the maintained region displaying the status of either of the driving support function and the automated driving function of the vehicle to a position and a size on a switched display screen, and
start generating the switched display screen after the region displaying the status of either of the driving support function and the automated driving function of the vehicle reaches the position and the size on the switched display screen.

6. The vehicular display apparatus according to claim 2,
wherein, when the display screens to be displayed on the display device are to be switched, the generating unit is configured to
generate a display screen by maintaining the display of a region displaying the status of either of the driving support function and the automated driving function of the vehicle in a pre-switching display screen and at least partially deleting a remaining region from the pre-switching display screen,
generate a display screen by changing the maintained region displaying the status of either of the driving support function and the automated driving function of the vehicle to a position and a size on a switched display screen, and
start generating the switched display screen after the region displaying the status of either of the driving support function and the automated driving function of the vehicle reaches the position and the size on the switched display screen.

7. The vehicular display apparatus according to claim 3,
wherein, when the display screens to be displayed on the display device are to be switched, the generating unit is configured to
generate a display screen by maintaining the display of a region displaying the status of either of the driving support function and the automated driving function of the vehicle in a pre-switching display screen and at least partially deleting a remaining region from the pre-switching display screen,
generate a display screen by changing the maintained region displaying the status of either of the driving support function and the automated driving function of the vehicle to a position and a size on a switched display screen, and
start generating the switched display screen after the region displaying the status of either of the driving support function and the automated driving function of the vehicle reaches the position and the size on the switched display screen.

8. The vehicular display apparatus according to claim 4,
wherein, when the display screens to be displayed on the display device are to be switched, the generating unit is configured to
generate a display screen by maintaining the display of a region displaying the status of either of the driving support function and the automated driving function of the vehicle in a pre-switching display screen and at least partially deleting a remaining region from the pre-switching display screen,
generate a display screen by changing the maintained region displaying the status of either of the driving support function and the automated driving function of the vehicle to a position and a size on a switched display screen, and
start generating the switched display screen after the region displaying the status of either of the driving support function and the automated driving function of the vehicle reaches the position and the size on the switched display screen.

9. The vehicular display apparatus according to claim 1, further comprising:
a first operational member and a second operational member operable by a vehicle occupant of the vehicle, the vehicle occupant operating each of the first operational member and the second operational member to switch the display screens to be displayed on the display device,
wherein the first operational member is configured to display either of selection buttons respectively corresponding to the display screens and a next button and a back button configured to be used for switching between the display screens in a predetermined sequence, the first operational member being configured to detect that one of the displayed buttons has been selected by the vehicle occupant,
wherein the second operational member comprises a physical switch configured to detect an operation performed by the vehicle occupant,
wherein the generating unit is configured to
select one of the display screens selected in accordance with the operation performed by the vehicle occupant as a display screen to be displayed on the display device when the first operational member detects the operation performed by the vehicle occupant, and
select a selection screen subsequent to a currently-displayed selection screen in the predetermined sequence preliminarily set for the display screens as a display screen to be displayed on the display device when the second operational member detects the operation performed by the vehicle occupant.

10. The vehicular display apparatus according to claim 2, further comprising:
a first operational member and a second operational member operable by a vehicle occupant of the vehicle, the vehicle occupant operating each of the first operational member and the second operational member to switch the display screens to be displayed on the display device,
wherein the first operational member is configured to display either of selection buttons respectively corresponding to the display screens and a next button and a back button configured to be used for switching between the display screens in a predetermined sequence, the first operational member being configured to detect that one of the displayed buttons has been selected by the vehicle occupant,
wherein the second operational member comprises a physical switch configured to detect an operation performed by the vehicle occupant,
wherein the generating unit is configured to
select one of the display screens selected in accordance with the operation performed by the vehicle occupant as a display screen to be displayed on the display device when the first operational member detects the operation performed by the vehicle occupant, and
select a selection screen subsequent to a currently-displayed selection screen in the predetermined sequence preliminarily set for the display screens as a display screen to be displayed on the display device when the second operational member detects the operation performed by the vehicle occupant.

11. The vehicular display apparatus according to claim 3, further comprising:
a first operational member and a second operational member operable by a vehicle occupant of the vehicle, the vehicle occupant operating each of the first operational member and the second operational member to switch the display screens to be displayed on the display device,
wherein the first operational member is configured to display either of selection buttons respectively corresponding to the display screens and a next button and a back button configured to be used for switching between the display screens in a predetermined sequence, the first operational member being configured to detect that one of the displayed buttons has been selected by the vehicle occupant,
wherein the second operational member comprises a physical switch configured to detect an operation performed by the vehicle occupant,
wherein the generating unit is configured to
select one of the display screens selected in accordance with the operation performed by the vehicle occupant as a display screen to be displayed on the display device when the first operational member detects the operation performed by the vehicle occupant, and
select a selection screen subsequent to a currently-displayed selection screen in the predetermined sequence preliminarily set for the display screens as a display screen to be displayed on the display device when the second operational member detects the operation performed by the vehicle occupant.

12. The vehicular display apparatus according to claim 4, further comprising:
a first operational member and a second operational member operable by a vehicle occupant of the vehicle, the vehicle occupant operating each of the first operational member and the second operational member to switch the display screens to be displayed on the display device,
wherein the first operational member is configured to display either of selection buttons respectively corresponding to the display screens and a next button and a back button configured to be used for switching between the display screens in a predetermined sequence, the first operational member being configured to detect that one of the displayed buttons has been selected by the vehicle occupant,
wherein the second operational member comprises a physical switch configured to detect an operation performed by the vehicle occupant,
wherein the generating unit is configured to
select one of the display screens selected in accordance with the operation performed by the vehicle occupant as a display screen to be displayed on the display device when the first operational member detects the operation performed by the vehicle occupant, and
select a selection screen subsequent to a currently-displayed selection screen in the predetermined sequence preliminarily set for the display screens as a display screen to be displayed on the display device when the second operational member detects the operation performed by the vehicle occupant.

13. The vehicular display apparatus according to claim 5, further comprising:
a first operational member and a second operational member operable by a vehicle occupant of the vehicle, the vehicle occupant operating each of the first operational member and the second operational member to switch the display screens to be displayed on the display device,
wherein the first operational member is configured to display either of selection buttons respectively corresponding to the display screens and a next button and a back button configured to be used for switching between the display screens in a predetermined sequence, the first operational member being configured to detect that one of the displayed buttons has been selected by the vehicle occupant,
wherein the second operational member comprises a physical switch configured to detect an operation performed by the vehicle occupant,
wherein the generating unit is configured to
select one of the display screens selected in accordance with the operation performed by the vehicle occupant as a display screen to be displayed on the display device when the first operational member detects the operation performed by the vehicle occupant, and
select a selection screen subsequent to a currently-displayed selection screen in the predetermined sequence preliminarily set for the display screens as a display screen to be displayed on the display device when the second operational member detects the operation performed by the vehicle occupant.

14. The vehicular display apparatus according to claim 6, further comprising:
a first operational member and a second operational member operable by a vehicle occupant of the vehicle, the vehicle occupant operating each of the first operational member and the second operational member to switch the display screens to be displayed on the display device,
wherein the first operational member is configured to display either of selection buttons respectively corresponding to the display screens and a next button and a back button configured to be used for switching between the display screens in a predetermined sequence, the first operational member being configured to detect that one of the displayed buttons has been selected by the vehicle occupant,
wherein the second operational member comprises a physical switch configured to detect an operation performed by the vehicle occupant,
wherein the generating unit is configured to
select one of the display screens selected in accordance with the operation performed by the vehicle occupant as a display screen to be displayed on the display device when the first operational member detects the operation performed by the vehicle occupant, and
select a selection screen subsequent to a currently-displayed selection screen in the predetermined sequence preliminarily set for the display screens as a display screen to be displayed on the display device when the second operational member detects the operation performed by the vehicle occupant.

15. The vehicular display apparatus according to claim 7, further comprising:
a first operational member and a second operational member operable by a vehicle occupant of the vehicle, the vehicle occupant operating each of the first operational member and the second operational member to switch the display screens to be displayed on the display device,
wherein the first operational member is configured to display either of selection buttons respectively corresponding to the display screens and a next button and a back button configured to be used for switching between the display screens in a predetermined sequence, the first operational member being configured to detect that one of the displayed buttons has been selected by the vehicle occupant,
wherein the second operational member comprises a physical switch configured to detect an operation performed by the vehicle occupant,
wherein the generating unit is configured to
select one of the display screens selected in accordance with the operation performed by the vehicle occupant as a display screen to be displayed on the display device when the first operational member detects the operation performed by the vehicle occupant, and
select a selection screen subsequent to a currently-displayed selection screen in the predetermined sequence preliminarily set for the display screens as a display screen to be displayed on the display device when the second operational member detects the operation performed by the vehicle occupant.

16. The vehicular display apparatus according to claim 8, further comprising:
a first operational member and a second operational member operable by a vehicle occupant of the vehicle, the vehicle occupant operating each of the first operational member and the second operational member to switch the display screens to be displayed on the display device,
wherein the first operational member is configured to display either of selection buttons respectively corresponding to the display screens and a next button and a back button configured to be used for switching between the display screens in a predetermined sequence, the first operational member being configured to detect that one of the displayed buttons has been selected by the vehicle occupant,
wherein the second operational member comprises a physical switch configured to detect an operation performed by the vehicle occupant,
wherein the generating unit is configured to
select one of the display screens selected in accordance with the operation performed by the vehicle occupant as a display screen to be displayed on the display device when the first operational member detects the operation performed by the vehicle occupant, and
select a selection screen subsequent to a currently-displayed selection screen in the predetermined sequence preliminarily set for the display screens as a display screen to be displayed on the display device when the second operational member detects the operation performed by the vehicle occupant.

17. A vehicular display apparatus to be applied to a vehicle, the vehicular display apparatus comprising:
a display device configured to display display screens in a switching manner, the display screens displaying status information of the vehicle in either of different combinations and layouts; and
circuitry configured to
generate the display screens to be displayed on the display device such that a status of either of a driving support function and an automated driving function of the vehicle is displayed on each of the display screens to be displayed in the switching manner on the display device.
